(19) United States
(12) Patent Application Publication
(10) Pub. No.: US 2015/0063380 A1
(43) Pub. Date: Mar. 5, 2015

(54) Method and Apparatus for Generating Ultrafast, High Energy, High Power Laser Pulses

(71) Applicant: Jian Liu, Sunnyvale, CA (US)

(72) Inventor: Jian Liu, Sunnyvale, CA (US)

(21) Appl. No.: 14/016,064

(22) Filed: Aug. 31, 2013

(51) Int. Cl. H01S 3/11; H01S 3/067

(52) U.S. Cl. CPC H01S 3/1106; H01S 3/067
USPC 372/6

(57) ABSTRACT

Methods and systems for generating ultrafast, high energy, high power fiber laser pulses are disclosed, including generating a sequence of signal laser pulses from a broadband, mode locked, seed fiber laser oscillator; using a pulse stretcher to stretch the signal laser pulses; using a pulse picker to down select the stretched laser pulses; using a wavelength separator to separate the down selected laser pulses into two or more wavelength channels; using two or more delays lines to independently adjust for time differences between the laser pulses of the two or more wavelength channels; using two or more amplifier chains to amplify the delay line adjusted laser pulses; using a wavelength combiner to combine the amplified laser pulses; and using a compressor to compress the combined laser pulses to emit an ultrafast, high energy, high power laser pulse. Other embodiments are described and claimed.

### I. BACKGROUND

The invention relates generally to the field of high energy and high power ultrafast fiber lasers. More particularly, the invention relates to spectral combining of multiple high power and high energy ultrafast fiber lasers sharing a single all fiber based seed oscillator to achieve multiple mJ and a few kW energy/power scaling ultrafast fiber laser.

### II. SUMMARY

In one respect, disclosed is an ultrafast, high energy, high power fiber laser comprising: a broadband, mode locked, seed fiber laser oscillator; a pulse stretcher comprising an input and an output, wherein the broadband, mode locked, seed fiber laser oscillator is coupled to the input of the pulse stretcher; a pulse picker comprising an input and an output, wherein the output of the pulse stretcher is coupled to the input of the pulse picker; a wavelength separator comprising an input and two or more outputs, wherein the output of the pulse picker is coupled to the input of the wavelength separator; two or more delay lines comprising inputs and outputs, wherein the two or more outputs of the wavelength separator are independently coupled to the inputs of the two or more delay lines; two or more amplifier chains comprising inputs and outputs, wherein the outputs of the two or more delay lines are independently coupled to the inputs of the two or more amplifiers chains; a wavelength combiner comprising two or more inputs and an output, wherein the outputs of the two or more amplifier chains are coupled to the two or more inputs of the wavelength combiner; and a compressor comprising an input and an output, wherein the output of the wavelength combiner is coupled to the input of the compressor and the output of the compressor is configured to emit laser pulses.

In another respect, disclosed is an ultrafast, high energy, high power fiber laser comprising: a broadband, mode locked, seed fiber laser oscillator, wherein the broadband, mode locked, seed fiber laser oscillator is configured to generate a sequence of signal laser pulses; a wavelength separator comprising an input and two or more outputs, wherein the broadband, mode locked, seed fiber laser oscillator is coupled to the input of the wavelength separator and wherein the wavelength separator is configured to separate the sequence of signal laser pulses into two or more spectrally separated channels; two or more amplifier chains comprising inputs and outputs, wherein the two or more outputs of the wavelength separator are coupled to the inputs of the two or more amplifiers chains and wherein each of the two or more amplifier chains are configured to independently amplify the two or more spectrally separated channels; and a wavelength combiner comprising two or more inputs and an output, wherein the outputs of the two or more amplifier chains are coupled to the two or more inputs of the wavelength combiner and wherein the wavelength combiner is configured to combine the amplified two or more spectrally separated channels and to emit laser pulses.

In another respect, disclosed is a method for generating ultrafast, high energy, high power fiber laser pulses, the method comprising: generating a sequence of signal laser pulses from a broadband, mode locked, seed fiber laser oscillator; using a pulse stretcher comprising an input and an output, wherein the sequence of signal laser pulses are coupled into the input of the pulse stretcher to stretch the sequence of signal laser pulses; using a pulse picker comprising an input and an output, wherein the stretched laser pulses from the output of the pulse stretcher are coupled into the input of the pulse picker to down select the stretched laser pulses; using a wavelength separator comprising an input and two or more outputs, wherein the down selected laser pulses from the output of the pulse picker are coupled into the input of the wavelength separator to separate the down selected laser pulses into two or more wavelength channels; using two or more delays lines comprising inputs and outputs, wherein the two or more wavelength channels are independently coupled into the inputs of the two or more delay lines to independently adjust for time differences between the laser pulses of the two or more wavelength channels; using two or more amplifier chains comprising inputs and outputs, wherein the laser pulses from the outputs of the two or more delays lines are independently coupled into the inputs of the two or more amplifiers to amplify the delay line adjusted laser pulses; using a wavelength combiner comprising two or more inputs and an output, wherein the amplified laser pulses from the outputs of the two or more amplifiers are coupled into the two or more inputs of the wavelength combiner to combine the amplified laser pulses; and using a compressor comprising an input and an output, wherein the laser pulses from the output of the wavelength combiner are coupled into the input of the compressor to generate ultrafast, high energy, high power laser pulses.

In yet another respect, disclosed is a method for generating ultrafast, high energy, high power fiber laser pulses, the method comprising: generating a sequence of signal laser pulses from a broadband, mode locked, seed fiber laser oscillator; using a wavelength separator comprising an input and two or more outputs, wherein the sequence of signal laser pulse is pulses are coupled into the input of the wavelength separator to separate the sequence of signal laser pulse pulses into two or more spectrally separated channels; using two or more amplifier chains comprising inputs and outputs, wherein the two or more spectrally separated channels are independently coupled into the inputs of the two or more amplifiers to independently amplify the two or more spectrally separated channels; and using a wavelength combiner comprising two or more inputs and an output, wherein the amplified two or more spectrally separated channels are coupled into the two or more inputs of the wavelength combiner to combine the amplified two or more spectrally separated channels and to emit laser pulses.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a diagram illustrating an ultra high energy fiber laser system, in accordance with some embodiments.

FIGS. 2A and 2B are a photograph of the seed laser and a graph of the broadband spectrum of the seed laser, in accordance with some embodiments.

FIGS. 3A and 3B are schematic illustrations of WDM modules, in accordance with some embodiments.

FIG. 4 is a schematic illustration of a single channel fiber amplifier for scaling energy, in accordance with some embodiments.

FIGS. 5A to 5E are a schematic illustration of an individual channel amplifier using PCF along with graphs of the properties of the output pulse, in accordance with some embodiments.

FIG. 6A to 6E are a schematic illustration of an individual channel amplifier using a kW femtosecond fiber laser amplifier along with graphs of the properties of the output pulse, in accordance with some embodiments.

FIG. 7 is a block diagram illustrating a method for generating ultrafast, high energy, high power laser pulses, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Though high energy ultrafast fiber lasers operating at wavelengths of 1 μm, 1.55 μm, and 2 μm have been developed in the last few years and are commercially available from companies such as IMRA America, Inc. and PolarOnyx Laser, Inc., average power at the kW level and pulse energy at the 3 mJ level are achieved through complicated coherent combining by using a solid state seed oscillator, bulk grating stretcher, and Yb doped large mode area (LMA) photonic crystal fiber (PCF) rod. An ideal high energy ultrafast fiber laser should include an all fiber based seed oscillator (not a bulky solid state seed oscillator), stretcher, and amplifiers. The connection between components (fiber combiner, LMA fiber, isolators, etc.) should mainly be done by fiber splicing to provide robust operation. However, due to the difficulty in fiber management, and handling nonlinearity and gain narrowing in fibers, the energy scaling has been limited in 100's μJ level and average power in 100 W level for the past a few years. The invention disclosed in this patent demonstrates a breakthrough in pulse energy scaling to mJ and/or average power scaling to kW.

Based on the ultrafast fiber laser technology disclosed in U.S. Pat. Nos. 7,508,848, 7,477,664, 7,477,665, 7,590,155, 7,477,667, 7,430,224, 7,477,666, 7,593,434, 7,505,489, 7,529,278, 7,526,003, 7,430,226, 7,440,173, 7,555,022, and 7,907,645, a high energy (up to 100 mJ) ultrafast (about 100 fs) fiber laser system is disclosed which overcomes the previously mentioned difficulties and which meets the requirement of high energy laser applications, such High field physics, X-ray generation, Laser weapons, material processing, and sensing. The disclosed method and system first stretches, pulse selects, and separates the electromagnetic radiation from a mode locked broadband fiber based seed laser oscillator. The separated electromagnetic radiation is then synchronized and controlled, with fs accuracy, with independent delay lines. Next, an amplifier chain independently amplifies the separated electromagnetic radiation to 0.1-10 mJ, followed by a spectral combining technique to combine multiple 0.1-10 mJ ultrafast fiber laser pulses to achieve multiple mJ (0.2-100) and a few kW energy/power scaling. Finally, a compressor is used to compresses to a shorter pulse, shorter than is achievable in each individual wavelength channel.

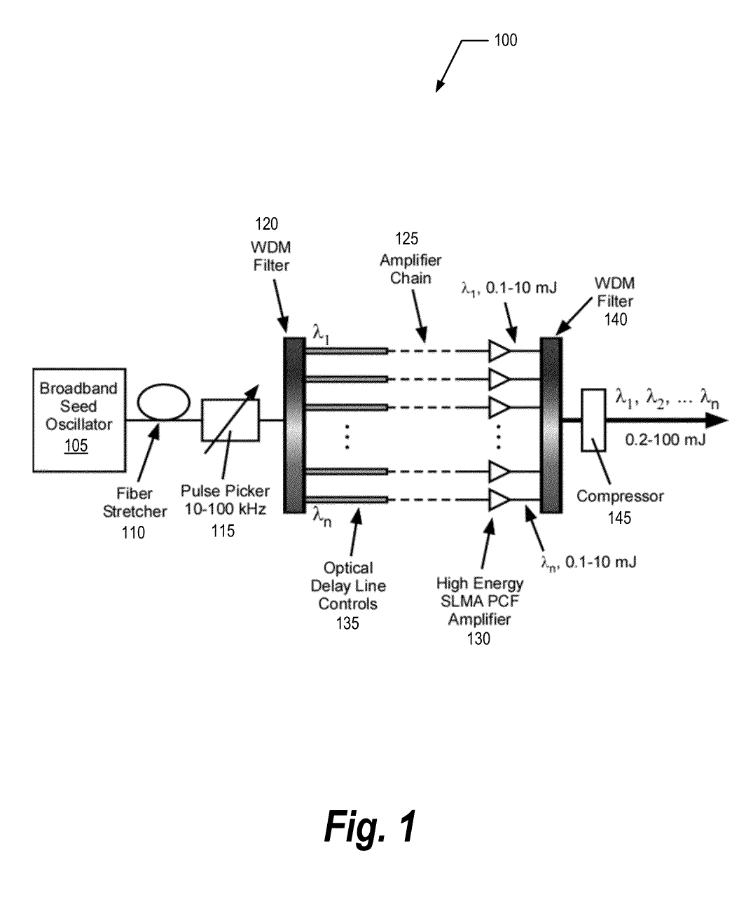

FIG. 1 is a diagram illustrating an ultra high energy fiber laser system, in accordance with some embodiments.

In some embodiments, an ultra high energy fiber laser system 100 comprises a phase-stabilized ultra broadband seed mode-locked ultrafast fiber laser 105 operating with a repetition rate at 10's of MHz. The output from the broadband seed oscillator 105 is coupled to a stretcher 110, such as a fiber stretcher or a volume holographic grating, to stretch the pulse to a ns pulse width (0.5 ns-10 ns). Next, a pulse picker 115 is coupled to down select the PRR to about 10 kHz to 2,000 kHz. In some embodiments, the pulse picker may not be used, thus keeping the laser system operating at 10's of MHz, i.e. the repetition rate of the broadband mode locked seed fiber laser oscillator. After pulse picking, the electromagnetic radiation of the pulse is separated into two or more wavelength regions or channels (slices), λ₁, λ₂, . . . λₙ. In one embodiment, a wavelength division multiplexer (WDM) filter 120 is used to divide the broadband spectrum of the seed fiber laser into multiple wavelength channels with enough bandwidth to support 100 fs pulse compression. In an alternate embodiment, the pulses from the broadband seed oscillator 105 may be stretched after being split into two or more wavelength regions. The stretched and wavelength separated pulses are then independently amplified through an amplifier chain 125 of a series of one or more fiber amplifiers, such as a high energy Super Large Mode Area (SLMA) PCF amplifier 130, to scale the pulse energy up to 10 mJ. Since the stretched and amplified multi-wavelength pulses share one seed and one modulator, all the pulses are naturally synchronized and phase coherent. Although, delay lines 135 are needed to adjust the linear delays between the various wavelength channels λ₁, λ₂, . . . λₙ (1 fs accuracy, 3 μm distance in free space). Commercial precision translation stages can achieve the required delays. After amplification, all the multiple wavelength channels are combined and then compressed. In one embodiment, another WDM 140 is used followed by a compressor 145, such as a fiber compressor or a grating compressor. The electromagnetic radiation that results has thus been scaled in energy multiple times. The single pulse energy ranges from about 0.2 mJ to about 100 mJ and has a pulse width from about 10 fs to about 100 ps. The average power ranges from about 200 W to about 100 kW. The system energy/power may be further scaled twice by employing polarization combining. For a Yb doped fiber laser amplifier, with its gain bandwidth of 1020-1100 nm, at least 8 channels (12 nm for supporting 100 fs pulse) may be used for spectral combining. For an Er doped fiber laser amplifier, at least 4 channels may be used for its 80 nm gain bandwidth. For a Tm doped fiber laser with gain bandwidth of 1850-2100 nm, at least 10 channels may be utilized. More interestingly, by combining multiple channels, the whole spectral bandwidth increases dramatically compared with each individual channel, thus being capable of supporting a much shorter pulse width on the order of about 10 fs.

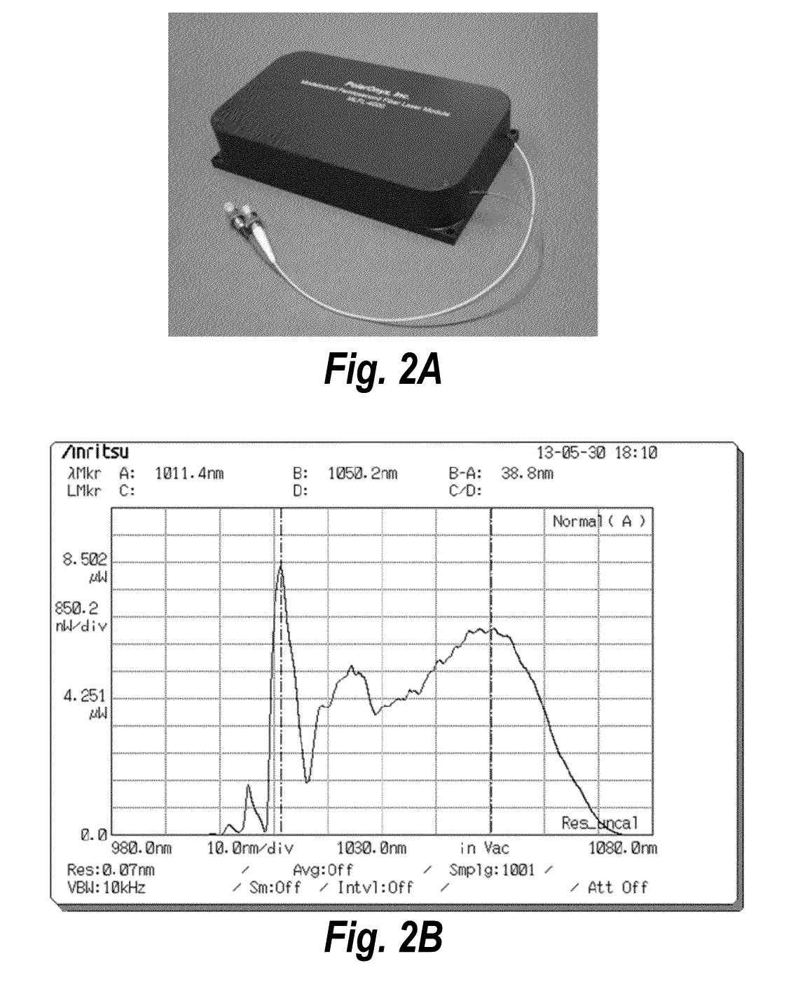

FIGS. 2A and 2B are a photograph of the seed laser and a graph of the broadband spectrum of the seed laser, in accordance with some embodiments.

In some embodiments, the broadband seed oscillator comprises an all fiber based fs fiber laser such as that disclosed in U.S. Pat. Nos. 7,907,645, 7,529,278, 7,526,003, 7,720,114, 7,477,664, 7,477,666, and 7,477,665. One such laser, from the Mercury Series of the Seed Mode Locked Femtosecond Fiber Lasers as shown in FIG. 2A, is commercially available from PolarOnyx Laser, Inc. Using such a seed oscillator simplifies the laser design and significantly improves the performance and reliability. The graph showing the 60 nm broad spectrum of the seed laser is shown in FIG. 2B.

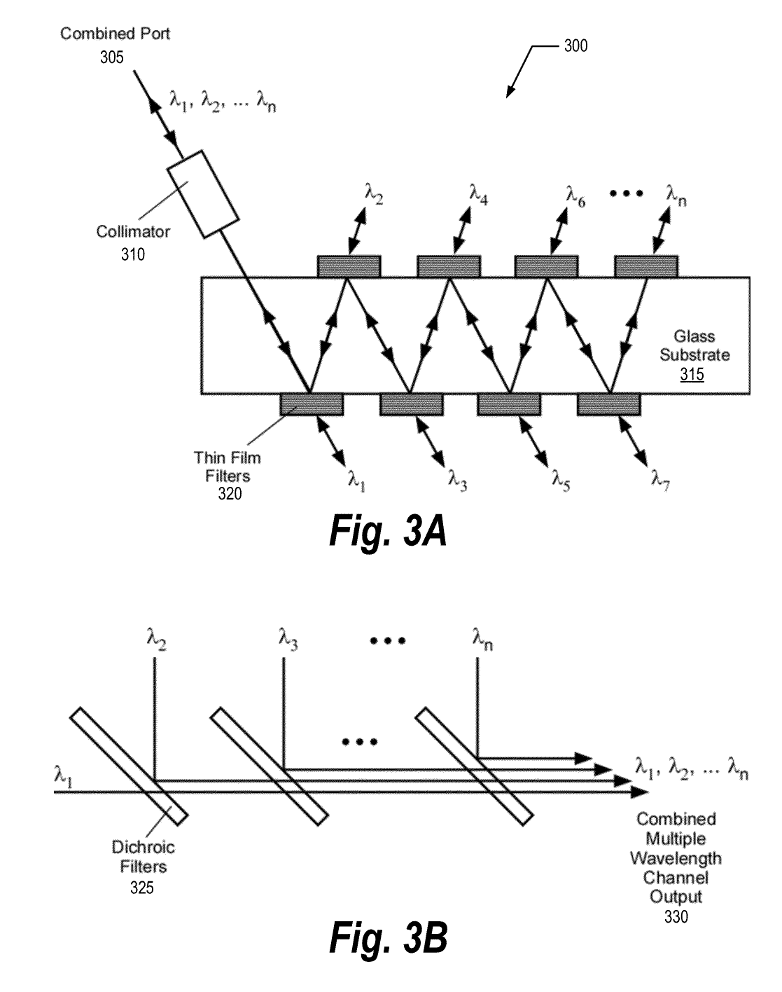

FIGS. 3A and 3B are schematic illustrations of WDM modules, in accordance with some embodiments.

In some embodiments, the WDM comprises a compact and robust substrate mode WDM. FIG. 3A illustrates one such compact substrate mode WDM 300. The combined port 305 collects multiple wavelength channels, λ₁, λ₂, . . . λₙ. The multiple wavelength channels are then collimated with a collimator 310 and coupled into a glass substrate 315 at a small angle, roughly 10 degrees. The glass substrate may be cooled for better thermal dissipation and the surface of the glass substrate may be coated with an antireflection coating to reduce the reflection and limit the loss. The coupled light then zigzags within the substrate wherein different colors of the multiple wavelength channels are coupled out, for beam separation, by thin film filters 320. The thin film filters are designed to transmit only one lasing wavelength channel and reflect the rest of the wavelength channels. In order to handle high energy and kW power operation, the thin film filters must be designed and fabricated with low loss (<0.1%) and high damage threshold. In the case where the WDM is used to combine multiple wavelength channels, the thin film filters 320 are used to couple in the multiple wavelength channels into the glass substrate and eventually all coupled out and collimated at the combined port. A combination of lenses with collimators is used to couple the wavelengths into or out of the thin film filters. FIG. 3B illustrates an alternative WDM for combining the multiple wavelength channels, λ₁, λ2, . . . λₙ, with a series of dichroic filters 325 into a multiple wavelength channel output 330. This alternative WDM may also be used for beam separation by coupling in the multiple wavelength channels at the output.

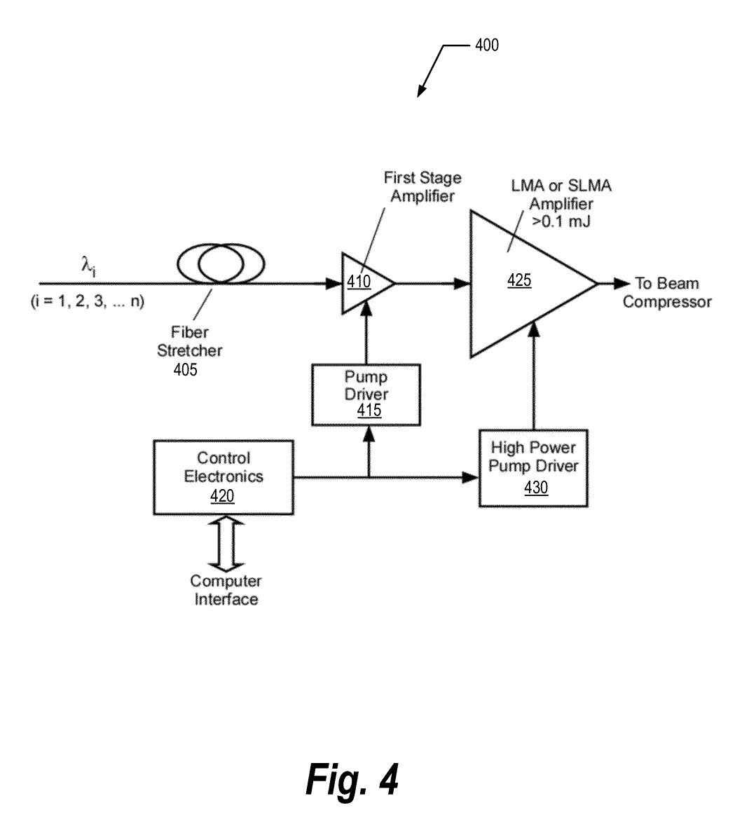

FIG. 4 is a schematic illustration of a single channel fiber amplifier for scaling energy, in accordance with some embodiments.

In some embodiments, in a single channel fiber amplifier 400, individual wavelength channel λᵢ, where i=1, 2, . . . n, is independently amplified through a series of fiber amplifiers to scale the pulse energy from 0.1 mJ to 10 mJ. The individual channel λᵢ is stretched in a fiber stretcher 405 from 0.5 ns to 10 ns to avoid serious nonlinear effects. After stretching, the laser pulse is amplified in a first stage amplifier 410 that is driven and controlled by a pump driver 415 and control electronics 420 which is interfaced to a computer. Additional stage amplifiers follow the first stage amplifier. The last stage amplifier 425 may comprise a large mode area (LMA) double cladding fiber, an LMA PCF, or a super large mode area (SLMA) PCF amplifier. The LMA fiber comprises a fiber core diameter from about 20 μm to about 80 μm, the LMA PCF comprises a fiber core diameter from 30 μm to 60 μm, and the SLMA PCF comprises a fiber core diameter from about 40 μm to about 200 μm. The LMA fiber results in the amplified laser pulse having a single pulse energy ranging from about 0.1 mJ to about 5 mJ. The SLMA PCF results in the amplified laser pulse having a single pulse energy ranging from about 100 to about 10 mJ. The last stage amplifier 425 is driven and controlled by a high power pump driver 430 and control electronics 420 which is interfaced to a computer. Depending on the wavelength and gain related to the individual wavelength channel, the fiber amplifiers may need to be optimized for highest energy/power extraction. After amplification, the individual wavelength channel λᵢ may be sent to a pulse compressor, such as grating pair or volume Bragg Grating (VBG). In an alternate embodiment, the individual wavelength channels may first be recombined and then the recombined laser pulse is subsequently compressed.

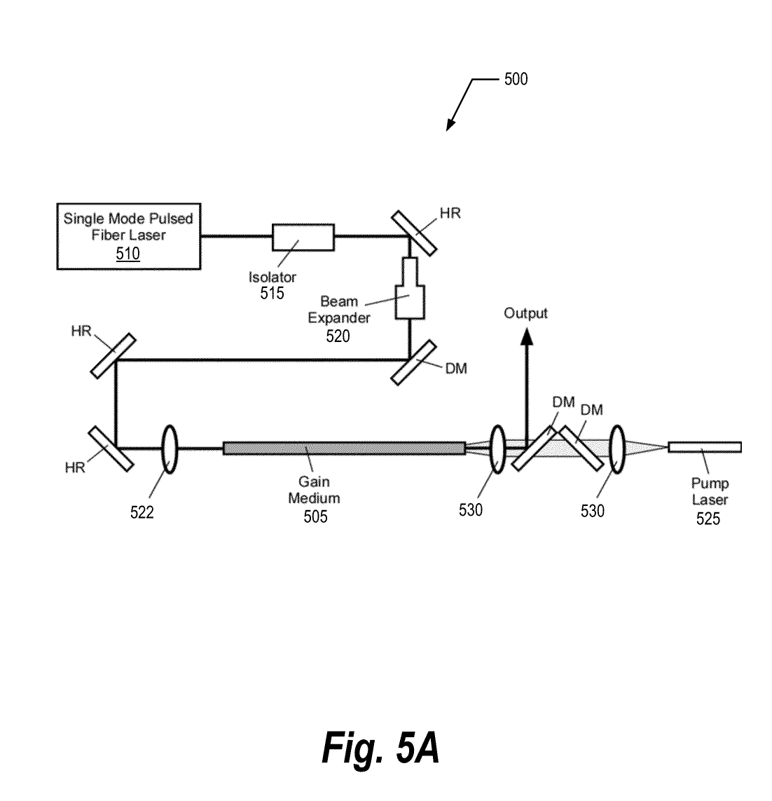

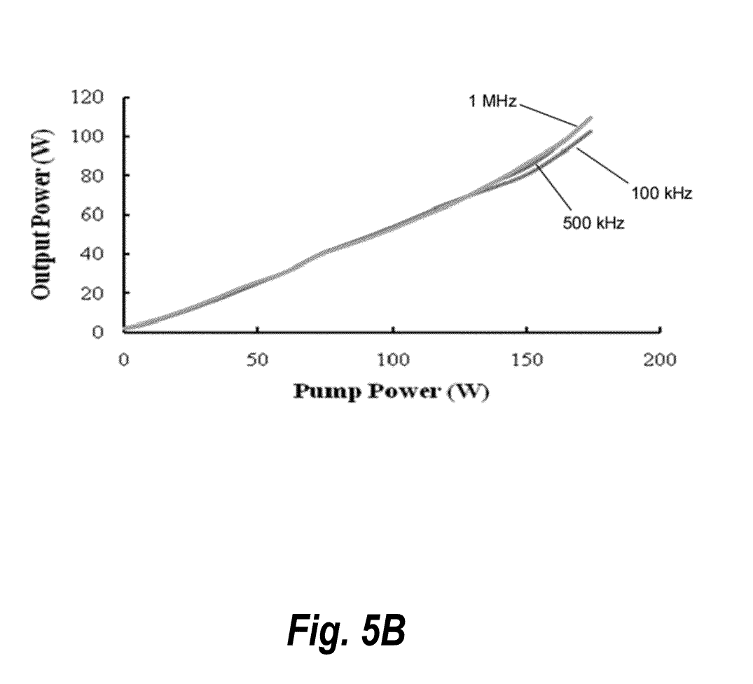

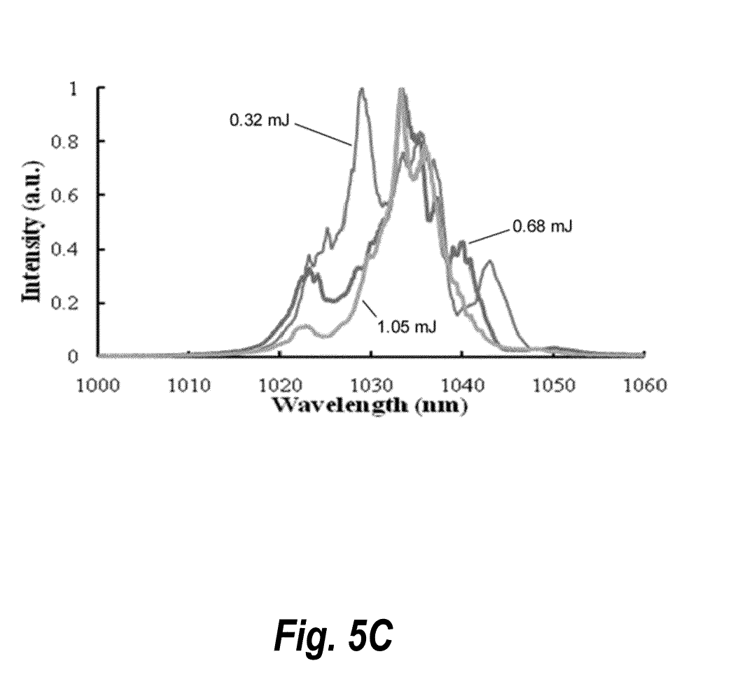

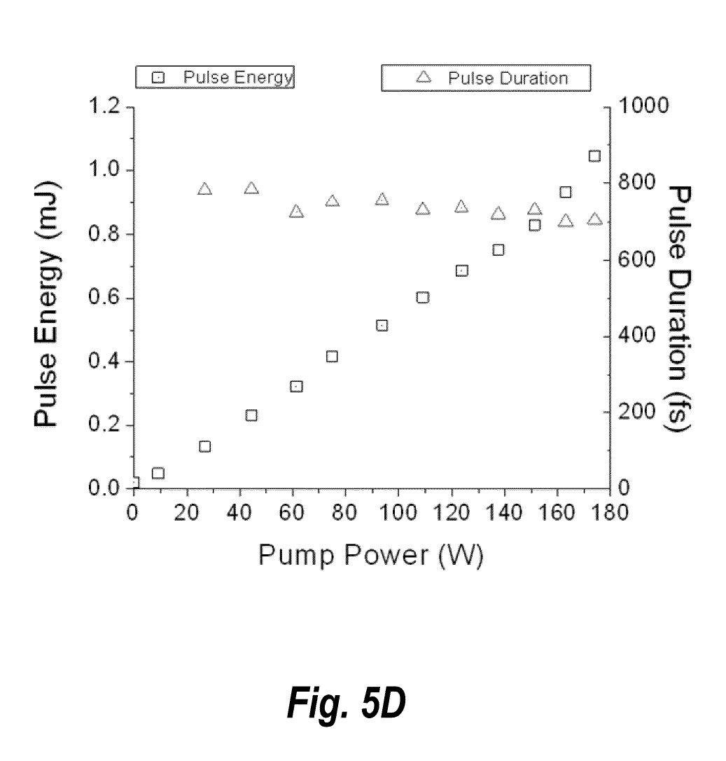

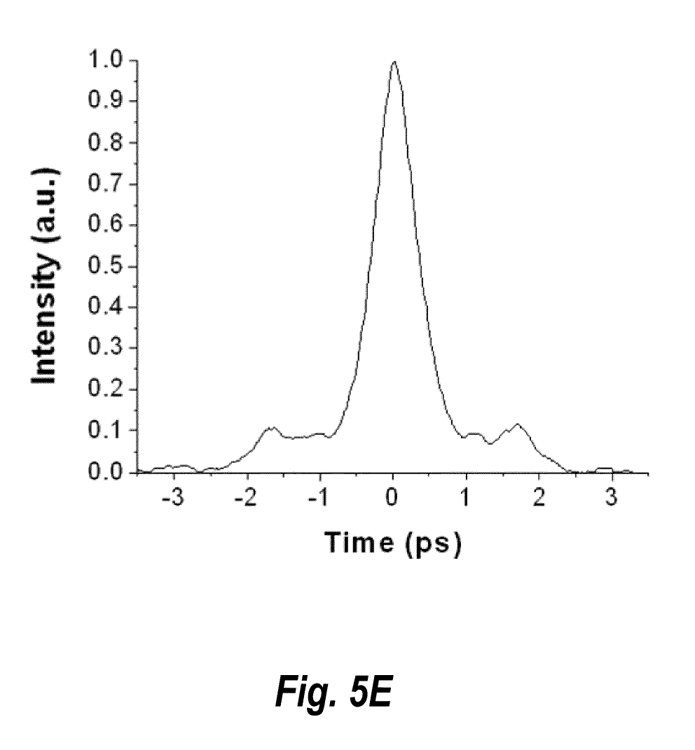

FIGS. 5A to 5E are a schematic illustration of an individual channel amplifier using PCF along with graphs of the properties of the output pulse, in accordance with some embodiments.

In some embodiments, the individual channel amplifier comprises a PCF rod amplifier. A single pass PCF amplifier test bed setup 500 is illustrated in FIG. 5A to demonstrate the achievable output from each of the multiple wavelength channels. The SLMA PCF rod gain medium 505 comprises a 80 cm long polarization maintaining (PM) Yb doped rod fiber commercially available from NKT Photonics A/S with a core diameter of 100 μm. The signal was generated from a single mode pulsed fiber laser 510, such as the commercially available Uranus Series 50 μJ Fiber Laser from PolarOnyx Laser, Inc. The central wavelength was around 1035 nm. The seed laser beam was firstly isolated with an isolator 515 and then resized by a combination of beam expander (1:3) 520 and then focused into the PCF 505 with a 75 mm focal length lens 522. A 976 nm pump beam was delivered from a pump laser 525 from the output side (counter pumping). Up to 174 W pump power was used in this experiment. The pump beam was collimated and re-focused to 250 μm in diameter, and then injected into the gain medium 505 by two aspherical lenses 530 with focal length of 11 mm. Multiple high reflectance mirrors (HR) and dichroic mirrors (DM) are used in the setup to ensure the pump and signal beam are completely split. The dichroic mirrors have high reflectance at 1030 nm and high transmittance at 940 nm. No extra cooling method was applied to the PCF 505. The output power of the single mode pulsed fiber laser 510 was set to 4.9 W (before the SLMA PCF). Up to a 103 W average power or 1.05 mJ pulse energy was achieved at a repetition rate of 98.13 kHz from the single pass PCF amplifier test bed setup 500. FIG. 5B shows the average output power as a function of pump power with seed laser repetition rates of 100 kHz, 500 kHz, and 1 MHz. FIG. 5C shows the output spectra with various output pulse energy levels at 98.13 kHz. The spectrum narrowing effect is observed with higher pulse energies. Pulse duration and pulse energy after pulse compression as functions of pump power are shown in FIG. 5D. The compressor was optimized for the highest pulse energy output. A pulse duration of 705 fs was obtained with amplified pulse energy of 1.05 mJ. After compression, 0.85 mJ is obtained. By using high efficiency gratings, close to 1 mJ after compression is achievable. The autocorrelation trace of this measurement with amplified pulse energy of 1.05 mJ is also shown in FIG. 5E. Beam quality factors (M² values) were measured as 1.37 and 1.29 in the X and Y axis respectively. By optimizing launching conditions and pump wavelengths and coupling, improvement of the beam quality to the diffraction limit is possible.

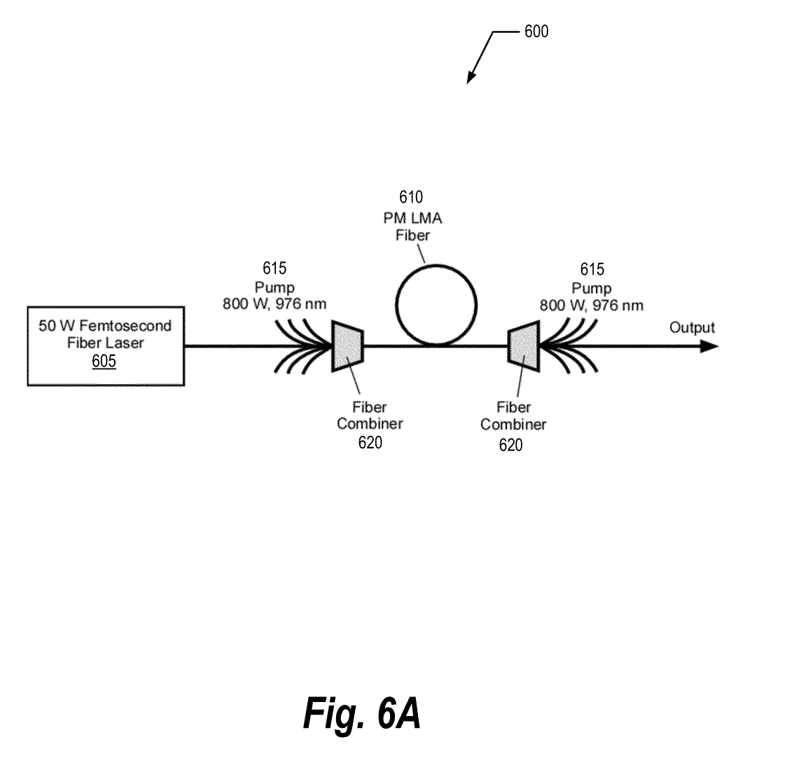

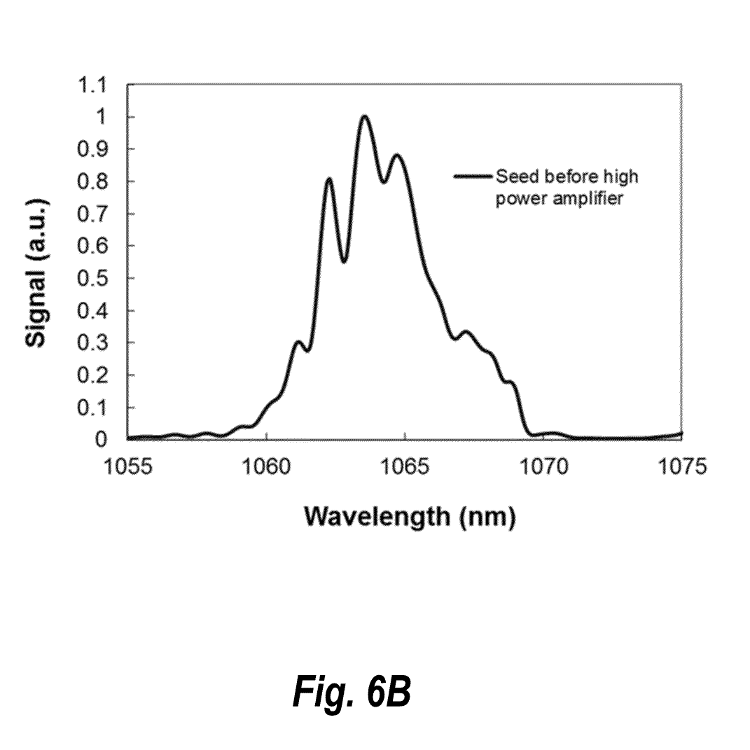

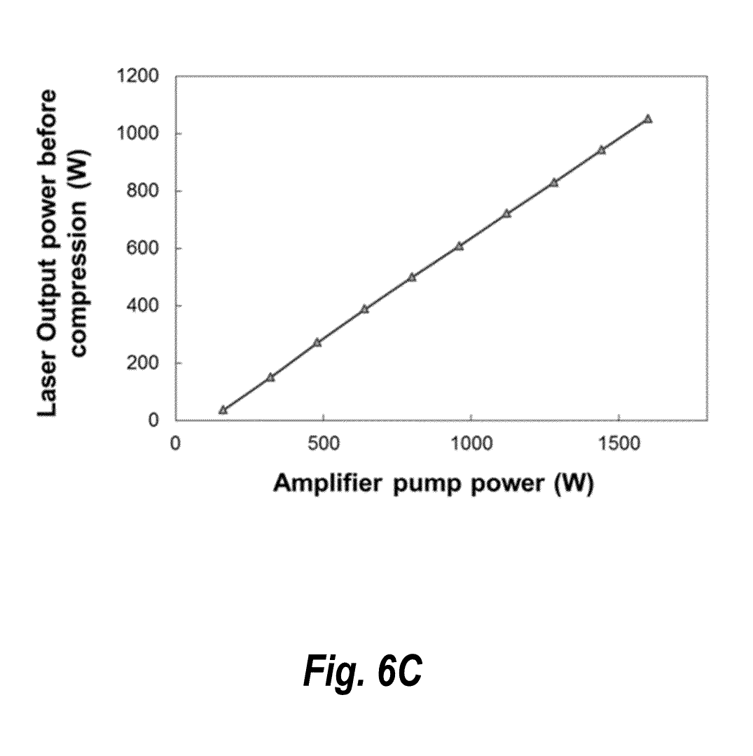

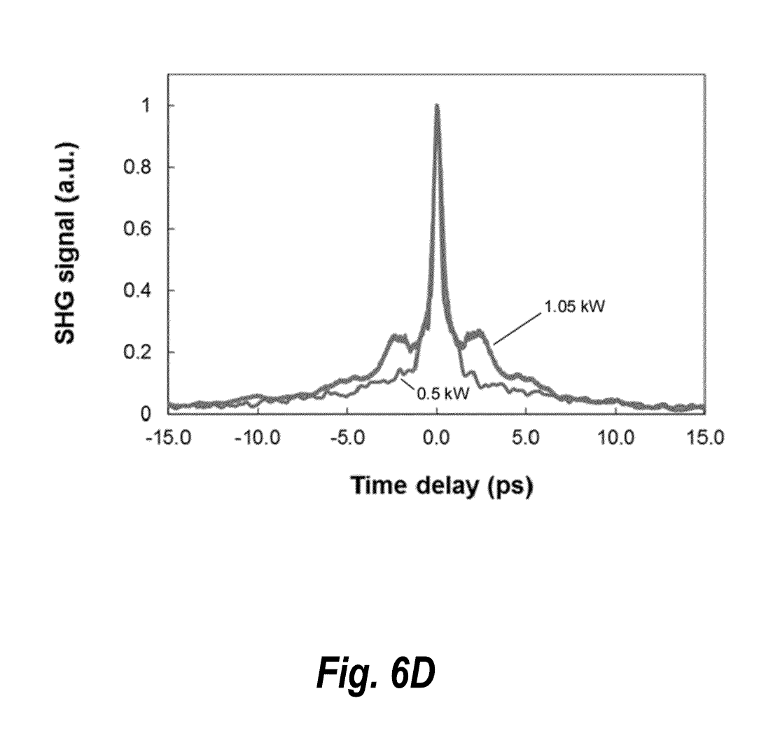

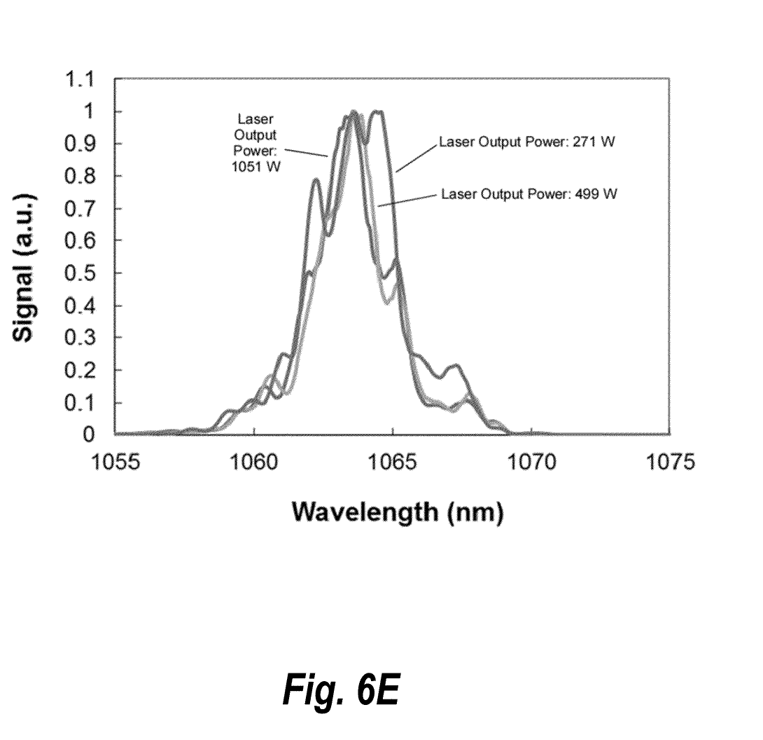

FIG. 6A to 6E are a schematic illustration of an individual channel amplifier using a kW femtosecond fiber laser amplifier along with graphs of the properties of the output pulse, in accordance with some embodiments.

In some embodiments, the individual channel amplifiers comprise a kW fiber amplifier. The design of a 1 kW fiber laser amplifier test bed setup 600 is illustrated in FIG. 6A to demonstrate the achievable output from each of the multiple wavelength channels. Bi-direction pumping was chosen for the kW fiber amplifier. The seeding laser 605, such as the commercially available Uranus Series 50 W Femtosecond Fiber Laser from PolarOnyx Laser, Inc. is used at a pulse repetition rate of 69 MHz and amplified by a polarization maintaining large mode fiber amplifier 610, such as the commercially available PLMA-YDF-30/400, 8 m fiber from Nufern. The kW fiber amplifier 610 was bi-directionally pumped by 976 nm, 800 W pump lasers 615 using two high power PM fiber combiners 620. The output power of the amplifier was measured using a prism to reduce the power and calibrated with a power meter. FIG. 6B shows the output spectrum of the seeding laser before amplification by the high power amplifier. FIG. 6C shows the laser output power after amplification but before compression versus the amplifier pump power. From the graph, it can be seen that the output power reaches 1 kW with a maximum pump power of 1600 W. A 65.7% power conversion efficiency was obtained. The amplified output power was tapped (4%) with a prism to reduce the power to a grating compressor to perform the pulse compression. The pulse width was measured by an autocorrelator and may be optimized to about 800 fs as shown in the autocorrelation traces shown in FIG. 6D at 0.5 kW and 1.05 kW. FIG. 6E shows the optical spectrum of the seed laser center wavelength at about 1064 nm and after kW amplification. Gain narrowing is observed as the amplified output power is increased.

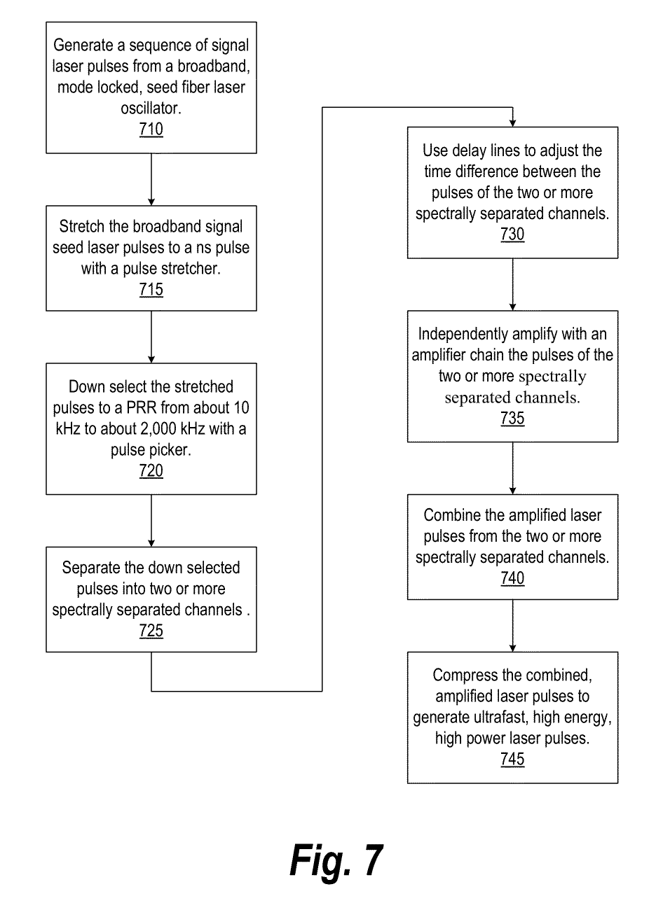

FIG. 7 is a block diagram illustrating a method for generating ultrafast, high energy, high power laser pulses, in accordance with some embodiments.

In some embodiments, the method illustrated in FIG. 7 may be performed by one or more of the devices illustrated in FIG. 1, FIG. 2A, FIG. 2B, FIG. 3A, FIG. 3B, FIG. 4, FIGS. 5A to 5E, and FIGS. 6A to 6E. At box 710, a broadband, mode locked, seed fiber laser oscillator is used to generate a sequence of signal laser pulses. The broadband signal seed laser pulses are then stretched to a 0.5 ns to 10 ns pulse width by a pulse stretcher at box 715. The pulse stretcher may comprise a fiber stretcher or a volume holographic grating. Next at box 720, the stretched pulses are down selected by a pulse picker to about 10 kHz to about 2,000 kHz. After down selecting the pulses, the pulses are separated into two or more spectrally separated channels at box 725. The pulses may be separated using a WDM. Next at box 730, delay lines are used to adjust the time difference between the pulses of the two or more spectrally separated channels. The delay lines may comprise a precision translation stages. Next at box 735, the pulses of the two or more spectrally separated channels are independently amplified with an amplifier chain. The amplifier chain may comprise a series of one or more fiber amplifiers, with the last stage amplifier comprising an LMA fiber, an LMA PCF, or an SLMA PCF amplifier. The amplified laser pulses from the two or more spectrally separated channels are combined at box 740. The pulses may be combined using a WDM. Finally, at box 745, the combined and amplified laser pulses are compressed to generate ultrafast, high energy, high power laser pulses. In alternate embodiments of the method, at least one of the pulse stretcher at box 715, the pulse picker at box 720, the delay lines at box 730, and the compressor at box 745 are not used.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention as detailed within the following claims.

1. An ultrafast, high energy, high power fiber laser comprising:
a broadband, mode locked, seed fiber laser oscillator, wherein the broadband, mode locked, seed fiber laser oscillator is configured to generate a sequence of signal laser pulses;
a wavelength separator comprising an input and two or more outputs, wherein the broadband, mode locked, seed fiber laser oscillator is coupled to the input of the wavelength separator and wherein the wavelength separator is configured to separate the sequence of signal laser pulses into two or more spectrally separated, coherently correlated channels;
two or more amplifier chains comprising inputs and outputs, wherein the two or more outputs of the wavelength separator are coupled to the inputs of the two or more amplifiers chains and wherein each of the two or more amplifier chains are configured to independently amplify the two or more spectrally separated, coherently correlated channels; and
a wavelength combiner comprising two or more inputs and an output, wherein the outputs of the two or more amplifier chains are coupled to the two or more inputs of the wavelength combiner and wherein the wavelength combiner is configured to combine the amplified two or more spectrally separated, coherently correlated channels and to emit laser pulses.

2. The ultrafast, high energy, high power fiber laser of claim 1, further comprising a pulse stretcher coupled between the broadband, mode locked, seed fiber laser oscillator and the wavelength separator, wherein the pulse stretcher is configured to stretch the sequence of signal laser pulses.

3. The ultrafast, high energy, high power fiber laser of claim 1, further comprising two or more pulse stretchers coupled between the wavelength separator and the two or more amplifier chains, wherein the two or more pulse stretchers are configured to independently stretch the two or more spectrally separated, coherently correlated channels.

4. The ultrafast, high energy, high power fiber laser of claim 1, further comprising a pulse picker coupled between the broadband, mode locked, seed fiber laser oscillator and the wavelength separator, wherein the pulse picker is configured to down select the sequence of signal laser pulses.

5. The ultrafast, high energy, high power fiber laser of claim 1, further comprising two or more delay lines coupled between the wavelength separator and the two or more amplifier chains, wherein the two or more delay lines are configured to independently adjust for time differences between the two or more spectrally separated, coherently correlated channels.

6. The ultrafast, high energy, high power fiber laser of claim 1, further comprising a compressor coupled to the output of the wavelength combiner, wherein the compressor is configured to compress the combined and amplified two or more spectrally separated, coherently correlated channels and to emit compressed laser pulses.

7. The ultrafast, high energy, high power fiber laser of claim 1, further comprising two or more compressors coupled between the two or more amplifier chains and the wavelength combiner, wherein the two or more compressors are configured to independently compress the amplified two or more spectrally separated, coherently correlated channels.

8. The ultrafast, high energy, high power fiber laser of claim 2, wherein the pulse stretcher comprises a volume holographic grating stretcher or a fiber.

9. The ultrafast, high energy, high power fiber laser of claim 1, wherein the laser pulses have an average power ranging from about 200 W to about 100 kW.

10. The ultrafast, high energy, high power fiber laser of claim 1, wherein the laser pulses have a pulse repetition rate ranging from about 10 kHz to about 2,000 kHz.

11. The ultrafast, high energy, high power fiber laser of claim 1, wherein the laser pulses have a single pulse energy ranging from about 0.2 mJ to about 100 mJ.

12. The ultrafast, high energy, high power fiber laser of claim 1, wherein the laser pulses have a pulse width ranging from about 0.5 ns to about 10 ns.

13. The ultrafast, high energy, high power fiber laser of claim 6, wherein the compressed laser pulses have a pulse width ranging from about 10 fs to about 100 ps.

14. The ultrafast, high energy, high power fiber laser of claim 1, wherein the wavelength separator comprises a WDM.

15. The ultrafast, high energy, high power fiber laser of claim 1, wherein the wavelength combiner comprises a WDM.

16. The ultrafast, high energy, high power fiber laser of claim 1, wherein at least one of the two or more amplifier chains comprises a PCF fiber amplifier, wherein the PCF fiber amplifier comprises a fiber core size ranging from about 30 μm to about 200 μm and is configured to emit amplified laser pulses having a single pulse energy ranging from about 100 μJ to about 10 mJ.

17. The ultrafast, high energy, high power fiber laser of claim 1, wherein at least one of the two or more amplifier chains comprises an LMA double cladding fiber amplifier, wherein the LMA double cladding fiber amplifier comprises a fiber core size ranging from about 20 μm to about 80 μm and is configured to emit amplified laser pulses having a single pulse energy ranging from about 0.1 mJ to about 5 mJ.

18. A method for generating ultrafast, high energy, high power fiber laser pulses, the method comprising:
generating a sequence of signal laser pulses from a broadband, mode locked, seed fiber laser oscillator;
using a wavelength separator comprising an input and two or more outputs, wherein the sequence of signal laser pulses are coupled into the input of the wavelength separator to separate the sequence of signal laser pulses into two or more spectrally separated, coherently correlated channels;
using two or more amplifier chains comprising inputs and outputs, wherein the two or more spectrally separated, coherently correlated channels are independently coupled into the inputs of the two or more amplifiers to independently amplify the two or more spectrally separated, coherently correlated channels; and
using a wavelength combiner comprising two or more inputs and an output, wherein the amplified two or more spectrally separated, coherently correlated channels are coupled into the two or more inputs of the wavelength combiner to combine the amplified two or more spectrally separated, coherently correlated channels and to emit laser pulses.

19. The method for generating ultrafast, high energy, high power fiber laser pulses of claim 18, further comprising using a pulse stretcher coupled between the broadband, mode locked, seed fiber laser oscillator and the wavelength separator, wherein the pulse stretcher is configured to stretch the sequence of signal laser pulses.

20. The method for generating ultrafast, high energy, high power fiber laser pulses of claim 18, further comprising using two or more pulse stretchers coupled between the wavelength separator and the two or more amplifier chains, wherein the two or more pulse stretchers are configured to independently stretch the two or more spectrally separated, coherently correlated channels.

21. The method for generating ultrafast, high energy, high power fiber laser pulses of claim 18, further comprising using a pulse picker coupled between the broadband, mode locked, seed fiber laser oscillator and the wavelength separator, wherein the pulse picker is configured to down select the sequence of signal laser pulses.

22. The method for generating ultrafast, high energy, high power fiber laser pulses of claim 18, further comprising using two or more delay lines coupled between the wavelength separator and the two or more amplifier chains, wherein the two or more delay lines are configured to independently adjust for time differences between the two or more spectrally separated, coherently correlated channels.

23. The method for generating ultrafast, high energy, high power fiber laser pulses of claim 18, further comprising using a compressor coupled to the output of the wavelength combiner, wherein the compressor is configured to compress the combined and amplified two or more spectrally separated, coherently correlated channels and to emit compressed laser pulses.

24. The method for generating ultrafast, high energy, high power fiber laser pulses of claim 18, further comprising using two or more compressors coupled between the two or more amplifier chains and the wavelength combiner, wherein the two or more compressors are configured to independently compress the amplified two or more spectrally separated, coherently correlated channels.

25. The method for generating ultrafast, high energy, high power fiber laser pulses of claim 9, wherein the pulse stretcher comprises a volume holographic grating stretcher or a fiber.

26. The method for generating ultrafast, high energy, high power fiber laser pulses of claim 18, wherein the laser pulses have an average power ranging from about 200 W to about 100 kW.

27. The method for generating ultrafast, high energy, high power fiber laser pulses of claim 18, wherein the laser pulses have a pulse repetition rate ranging from about 10 kHz to about 2,000 kHz.

28. The method for generating ultrafast, high energy, high power fiber laser pulses of claim 18, wherein the laser pulses have a single pulse energy ranging from about 0.2 mJ to about 100 mJ.

29. The method for generating ultrafast, high energy, high power fiber laser pulses of claim 18, wherein the laser pulses have a pulse width ranging from about 0.5 ns to about 10 ns.

30. The method for generating ultrafast, high energy, high power fiber laser pulses of claim 23, wherein the compressed laser pulses have a pulse width ranging from about 10 fs to about 100 ps.

31. The method for generating ultrafast, high energy, high power fiber laser pulses of claim 18, wherein the wavelength separator comprises a WDM.

32. The method for generating ultrafast, high energy, high power fiber laser pulses of claim 18, wherein the wavelength combiner comprises a WDM.

33. The method for generating ultrafast, high energy, high power fiber laser pulses of claim 18, wherein at least one of the two or more amplifier chains comprises a PCF fiber amplifier, wherein the PCF fiber amplifier comprises a fiber core size ranging from about 30 μm to about 200 μm and is configured to emit amplified laser pulses having a single pulse energy ranging from about 100 μJ to about 10 mJ.

34. The method for generating ultrafast, high energy, high power fiber laser pulses of claim 18, wherein at least one of the two or more amplifier chains comprises an LMA double cladding fiber amplifier, wherein the LMA double cladding fiber amplifier comprises a fiber core size ranging from about 20 μm to about 80 μm and is configured to emit amplified laser pulses having a single pulse energy ranging from about 0.1 mJ to about 5 mJ.
